(19) United States
(12) Patent Application Publication
(10) Pub. No.: US 2012/0306200 A1
(43) Pub. Date: Dec. 6, 2012

(54) Fitting Assembly For Conveying Fluids Under High Pressure

(76) Inventor: Seann Pavlik, Fort Lauderdale, FL (US)

(21) Appl. No.: 13/489,225

(22) Filed: Jun. 5, 2012

Related U.S. Application Data
(60) Provisional application No. 61/520,100, filed on Jun. 6, 2011.

(51) Int. Cl. F16L 33/18

(52) U.S. Cl. 285/344

(57) ABSTRACT

A fitting assembly for conveying a fluid under high pressure includes a first conduit including an outer diameter of the first conduit, a second conduit of circular cross-section defining an inside diameter to receive the first conduit. The fitting assembly further includes a circumferential sealing mechanism for coupling the second conduit to the first conduit after the first conduit is inserted into the smooth circular end of the second conduit. Particularly, the sealing mechanism is located within the second conduit before the female threads therein.

### CROSS REFERENCE TO RELATED APPLICATION

This application claims the benefit under 35 USC 119 (e) of the provisional patent application Ser. No. 61/520,100, filed Jun. 6, 2011, which is hereby incorporated by reference in its entirety.

### FIELD OF THE INVENTION

Embodiments of the present invention generally relate to fitting assemblies, and, more particularly, to fitting assemblies for conveying fluids under high pressure.

### BACKGROUND OF THE INVENTION

Numerous fitting assemblies are used to transport fluid in household and industrial applications. Generally, the fitting assemblies employing pipes and tubes available in the prior art suffer from the problem of fluid leakage occurring in the junction between the pipefitting and the piping. Moreover, frequent fluid leakage is also seen at the distal end of the piping.

Currently, the outer threads of the pipefitting are wound with several rounds of seal tape so as to eliminate the gaps between the assembled pipefitting and corresponding assembling structure, thereby preventing the occurrence of leakage. However, this kind of technique has reduced effect on leakage prevention. Moreover, the overall technique of using seal tape is laborious and requires much more time. Furthermore, the seal tape cannot be used repeatedly or re-used so there is wastage of seal tape.

Hydraulic couplings have also been employed to prevent the occurrence of leakage. In operation, hydraulic couplings provide sealing mechanism for a coupling element when said element is in an uncoupled configuration by means of an O-ring housed at the interface between the pusher and the valve. While the element is being coupled with a corresponding element, the sliding of the valve relative to the pusher positions the sealing O-ring in contact with the fluid flow section in the coupling. However, with high fluid flow rates, there remains a possibility of the sealing O-ring being expelled from its housing when the coupling is in the coupled configuration, consequently giving rise to sealing problems on uncoupling.

Accordingly, there remains a need in the art for an improved fitting assembly for conveying fluids under high pressure and prevent fluid leakage.

### SUMMARY OF THE INVENTION

In accordance with an embodiment of the present invention, a fitting assembly for conveying a fluid under high pressure includes a first conduit including an outer diameter, a second conduit of circular cross-section defining an inside diameter to receive the first conduit. Moreover, the second conduit includes a smooth circular end having an inner diameter to position the first conduit in place inside the second conduit, and a threaded end with multiple female threads on the inner diameter adjacent to the smooth circular end for engaging the first conduit inside the second conduit. Furthermore, the fitting assembly includes a circumferential sealing mechanism for coupling the second conduit to the first conduit after the first conduit is inserted into the circular end of the second conduit. Particularly, the sealing mechanism is located within the second conduit before the female threads therein.

In accordance with an embodiment of the present invention, the sealing mechanism may include at least one resilient gasket or an o-ring. The at least one gasket is mounted circumferentially within the inner diameter of the smooth circular end before a beginning of the multiple female threads. Particularly, the at least one gasket defines a fluid-tight press-fit to the first conduit when inserted into the second conduit enabling conveyance of the fluid under high pressure without loss of integrity of pressure or fluid flow.

In accordance with one embodiment of the present invention, the at least one gasket is an O-ring.

### BRIEF DESCRIPTION OF THE DRAWINGS

FIG. 1 illustrates a perspective view of a first conduit and a second conduit of a fitting assembly for conveying fluids under high pressure in an unassembled position, according to an embodiment of the invention.

FIG. 2 and FIG. 3 illustrate a perspective view of the first conduit rotatably inserted inside the second conduit to form the fitting assembly for conveying fluids under high pressure, according to an embodiment of the invention.

FIG. 4 illustrates a cross-sectional view of the first conduit and the second conduit of the fitting assembly along the axis of rotation of the fitting assembly of FIG. 3, according to an embodiment of the invention.

FIG. 5 illustrates a cross-sectional view of the first conduit rotatably inserted inside the second conduit to form the fitting assembly for conveying fluids under high pressure, taken along Line 5-5 of FIG. 3.

FIG. 6B illustrates a cross-sectional front view of an elbow coupling with a fitting assembly (FIG. 6A) for conveying fluids under high pressure, according to an embodiment of the invention;

FIG. 7 illustrates the first conduit and the second conduit of the fitting assembly for conveying fluids under high pressure, according to an alternate embodiment of the invention; and

FIG. 8 illustrates the first conduit and the second conduit of the fitting assembly for conveying fluids under high pressure, according to an alternate embodiment of the invention.

### DETAILED DESCRIPTION OF THE INVENTION

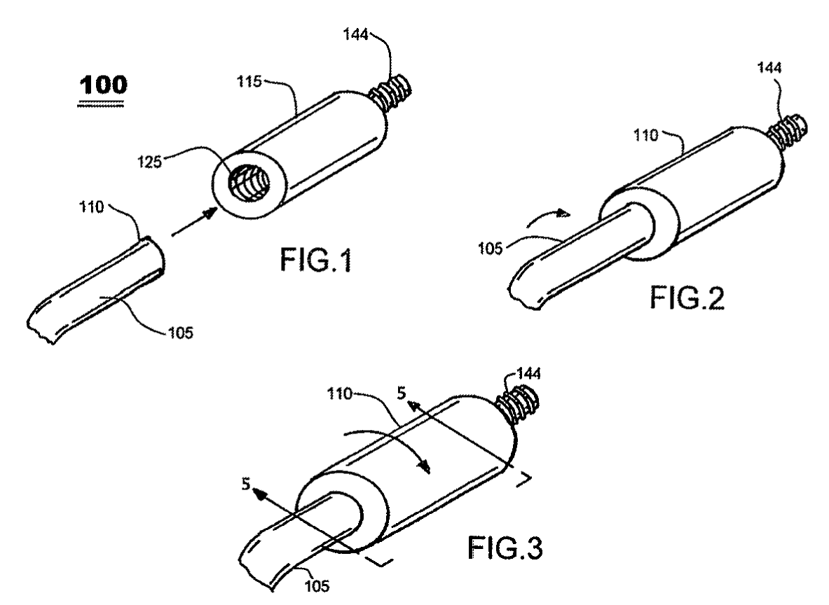

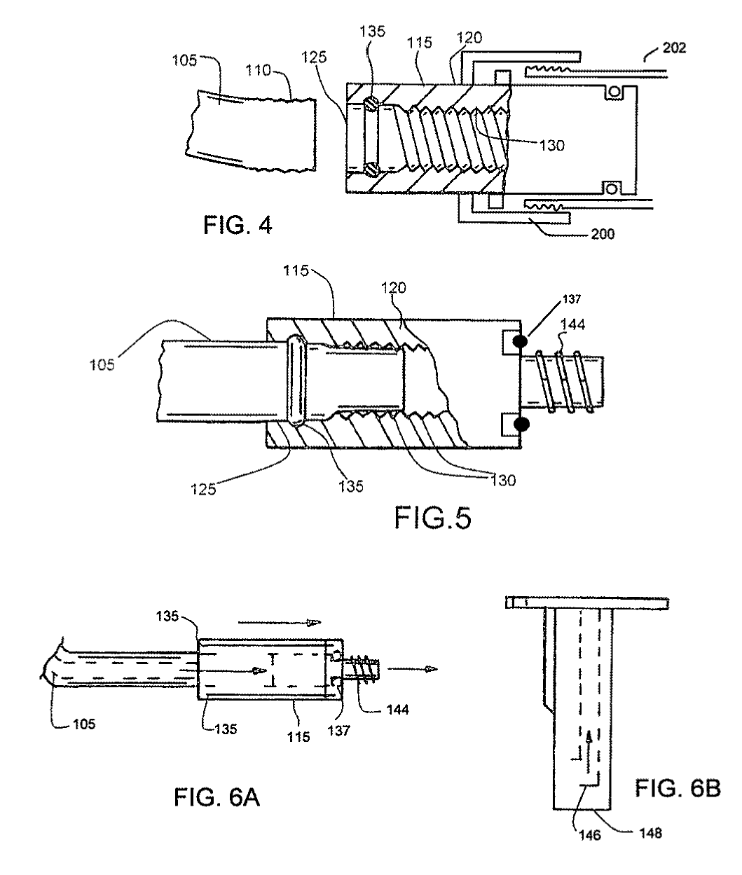

With reference to FIGS. 1-5, a fitting assembly for conveying a fluid under high pressure includes a first preferably flexible conduit 105 including a smooth end 110 on an outer diameter of the conduit 105. The fitting assembly 100 further includes a second conduit 115 of circular cross-section defining an inner diameter 125 to receive the first conduit 105. Particularly, the second conduit 115 includes a smooth circular input having said inner diameter 125 to position the first conduit 105 in place inside the second conduit 115 having a threaded end with multiple female threads 130 on the inner diameter 125 beyond the smooth circular end 125 for engaging the first conduit 105 inside the second conduit 115 as illustrated in cross-sectional view of FIG. 4 of the first conduit 105 and the second conduit 115 of the fitting assembly 100 along the axis of rotation of the coupled assembly, according to an embodiment of the invention.

In accordance the invention, the fitting assembly further includes a circumferential sealing mechanism 135 coupling the second conduit 115 to the first conduit 105 after smooth end 110 of the conduit is inserted into the smooth input of the second conduit 115. Generally, the sealing mechanism 135 is located within a groove of the second conduit 115 before the female threads 130. Therein as illustrated in FIG. 5 the first conduit 105 is rotatably inserted inside the second conduit 115 to form the fitting assembly 100 for conveying fluids under high pressure, according to an embodiment of the invention.

In use, the first conduit 105, whether threaded or not, is rotatably inserted within the multiple female threads 130 of the second conduit 115 and the outer diameter of the first conduit 105 is in rotational communication with the inner diameter 125 of the second conduit 115 to form the fitting assembly 100 as illustrated in FIGS. 2, 3, 5, 6 and 7 of the present invention, according to the shown embodiments of the invention.

In accordance with an embodiment of the present invention, the sealing mechanism further includes at least one resilient gasket 135, which is mounted circumferentially within the inner diameter 125 of the smooth circular end before a beginning of the multiple female threads 130 as illustrated in FIG. 4 of the present invention. Particularly, the at least one gasket 135 defines a fluid-tight press-fit to the first conduit 105 when inserted into the second conduit 115 enabling conveyance of the fluid under high pressure without loss of integrity of pressure or fluid flow. An assembly securing collar 200 with its female portion 202 is also shown in FIG. 4 which also illustrates that end 110 may be either roughened, irregular, threaded or smooth.

In use, the at least one gasket 135 is mounted in a recessed groove formed about the inner diameter 125 of the smooth circular end of the second conduit 115 by deforming at least a portion of the inner diameter 125 of the gasket 135 in an inner radial direction. Particularly, the at least one gasket 135 in the present invention is an O-ring to produce a fluid-tight seal between the first conduit 105 and the second conduit 115. Moreover, the O-ring 135 performs both the locking function, and the sealing function.

In accordance with an embodiment of the present invention, the multiple male threads 110 of the first conduit 105 are inserted into the inner diameter 125 of the smooth circular end of the second conduit 115 while the O-ring 135 is press-fit against the outer diameter of at least one male threading (if employed) of the first conduit 105 before and during contact with the multiple female threads 130.

FIG. 6A illustrates a cross-sectional front view of an elbow coupling 148 with the fitting assembly 100 for conveying fluids under high pressure, according to an embodiment of the invention. The coupling includes the threaded extension 144 of the fitting assembly 100 connected to the elbow coupling or flush mount plate 148 of an external fluid line 146 to convey fluids under high pressure, according to an embodiment of the invention. See FIG. 6B. However, it should be noted that a coupling illustrated in accordance with the present invention could be provided in many configurations, such as said elbow coupling 148, a T-coupling, a transition coupling and the like. FIGS. 5 and 6A also show that O-rings 137 may be employed, at the right side of the coupling, following threading 144.

In accordance with an embodiment of the present invention, the first conduit 105 is formed of a flexible polymeric material. Particularly, the flexible polymeric material is selected from at least one of a lower density polymeric material, other plastic material, and the like. Furthermore, the lower density polymeric material is polystyrene. However, the present invention is not limited to lower density polymeric material and any other suitable plastics and composite materials strong enough for the intended use may be employed.

In accordance with an alternate embodiment of the present invention, the first conduit 105 is formed of a rigid material.

In accordance with an embodiment of the present invention, the second conduit 115 is formed from a rigid material. Particularly, the rigid material may be any type of metal selected from aluminum, copper and copper alloys such as brass, tin, and the like.

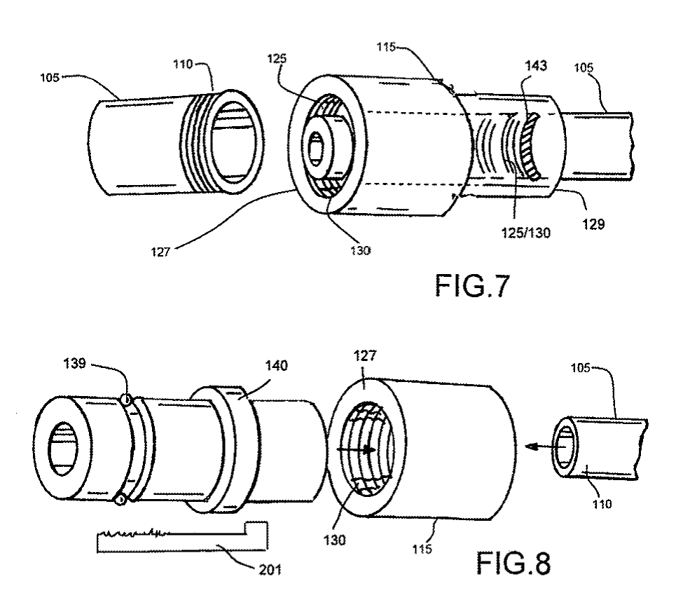

In accordance with another embodiment (see FIG. 7) of the present invention, the inner diameter 125 of the second conduit 115 opens at first and second ends thereof. Particularly, the inner diameter 125 of the second conduit 115 defines an inside volume open at both the first and second ends 127 and 129 thereof. The first conduit 105 is connected to the inside volume of the second conduit 115 via t O-ring sealing means 143 at the second end 129 of the second conduit 115. The first 127 end of the second conduit 115 includes multiple female threads 130 on the inner diameter 125 to position the first conduit 105 in place inside the second conduit 115. In accordance with a related embodiment of the present invention, an interior of a second end 127 of the second conduit 115 includes a rigid male surface 140. Moreover, the rigid male surface 140 of the second conduit 115 includes O-ring sealing means 139 therein proximally to the male surface thereof as illustrated in FIG. 8, of the present invention. An assembly securing ring 201 is conceptually shown.

In accordance with yet another embodiment of the present invention, the interior of the second end of the second conduit 115 includes a rigid threaded female surface.

Therefore, as may be seen, the present invention provides a fitting assembly for conveying fluids under high pressure. The fitting assembly serves to prevent leakage of a fluid flowing under high pressure through the conduit. The combination of the O-ring near the entrance to the second conduit and the interlock mechanism of the respective threading of the first conduit and the second conduit provide high pressure locking of the first conduit and the second conduit.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith. Therefore, the appended claims are to be construed to cover all equivalents falling within the true scope and spirit of the invention.

1. A fitting assembly for conveying a fluid under high pressure, said assembly comprising:
(a) a first conduit having an outer diameter, said diameter having a smooth surface;
(b) a second conduit of circular cross-section defining an inside diameter to receive said first conduit, said second conduit comprising an input having an inner diameter to position said first conduit in place inside said second conduit, and a threaded end after the input with a plurality of female threads on said inner diameter adjacent to said smooth input for engaging said first conduit inside said second conduit; and
(c) a circumferential sealing mechanism for coupling said second conduit to said first conduit after it is inserted into said smooth input of said second conduit, said sealing mechanism located in a groove within said second conduit outwardly of said plurality of female threads therein.

2. The fitting assembly as recited in claim 1, said first conduit rotatably insertable within said plurality of female threads of said second conduit and said first conduit in rotational communication with said inner diameter of said second conduit.

3. The fitting assembly as recited in claim 2, wherein said sealing mechanism further comprises:
at least one resilient gasket, said at least one gasket being mounted circumferentially within said inner diameter of said smooth input before a beginning of said plurality of female threads.

4. The fitting assembly as recited in claim 3, wherein said at least one gasket defines a fluid-tight press-fit to said first conduit when inserted into said second conduit enabling conveyance of said fluid under high pressure without loss of integrity of pressure or fluid flow.

5. The fitting assembly as recited in claim 4, wherein said at least one gasket is mounted in a recessed groove formed about said inner diameter of said smooth circular end of said second conduit by deforming at least a portion of said inner diameter of the gasket in an inner radial direction.

6. The fitting assembly as recited in claim 5, wherein said at least one gasket is an O-ring.

7. The fitting assembly as recited in claim 4, said first conduit is inserted into said inner diameter of said circular end of said second conduit while said O-ring is press-fit against said outer diameter of said first conduit before and during contact with said plurality of female threads.

8. The fitting assembly as recited in claim 1, said inner diameter of said second conduit open at first and second ends thereof.

9. The fitting assembly as recited in claim 1, wherein said second conduit further comprises a threaded extension for coupling said fitting assembly with an external fluid line.

10. The fitting assembly as recited in claim 1, wherein said first conduit is formed of a flexible polymeric material having a threaded end.

11. The fitting assembly as recited in claim 9, wherein a polymeric material is selected from at least one of a lower density polymeric material, other plastic material, and the like, to form said first conduit.

12. The fitting assembly as recited in claim 11, wherein said lower density polymeric material is polystyrene.

13. The fitting assembly as recited in claim 7, wherein said first conduit is formed of a rigid material.

14. The fitting assembly as recited in claim 7, wherein said second conduit is formed from a rigid material.

15. The fitting assembly as recited in claim 8, in which an interior of said second end of said second conduit comprises a rigid threaded male surface.

16. The fitting assembly as recited in claim 8, in which an interior of said second end of said second conduit comprises a rigid threaded female surface.

17. A fitting assembly for conveying a fluid under high pressure, said assembly comprising:
(a) a first conduit having an outer diameter, said diameter having a roughed surface;
(b) a second conduit of circular cross-section defining an inside diameter to receive said first conduit, said second conduit comprising an input having an inner diameter to position said first conduit in place inside said second conduit, and a threaded end after the input with a plurality of female threads on said inner diameter adjacent to said smooth input for engaging said first conduit inside said second conduit; and
(c) a circumferential sealing mechanism for coupling said second conduit to said first conduit after it is inserted into said smooth input of said second conduit, said sealing mechanism located in a groove within said second conduit outwardly of said plurality of female threads therein.

18. The fitting assembly as recited in claim 17, said first conduit rotatably insertable within said plurality of female threads of said second conduit and said first conduit in rotational communication with said inner diameter of said second conduit.

19. The fitting assembly as recited in claim 18, wherein said sealing mechanism further comprises:
at least one resilient gasket, said at least one gasket being mounted circumferentially within said inner diameter of said smooth input before a beginning of said plurality of female threads.

20. The fitting assembly as recited in claim 19, wherein said at least one gasket defines a fluid-tight press-fit to said first conduit when inserted into said second conduit enabling conveyance of said fluid under high pressure without loss of integrity of pressure or fluid flow.
